(19) United States
(12) Patent Application Publication
(10) Pub. No.: US 2007/0176879 A1
(43) Pub. Date: Aug. 2, 2007

(54) Liquid crystal display device

(75) Inventors: Tetsuya Makino, Kakogawa (JP); Toshiaki Yoshihara, Kawasaki (JP); Shinji Tadaki, Kawasaki (JP); Hironori Shiroto, Kobe (JP); Yoshinori Kiyota, Kawasaki (JP); Shigeo Kasahara, Kawasaki (JP); Keiichi Betsui, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/728,946

(22) Filed: Mar. 27, 2007

Related U.S. Application Data
(63) Continuation of application No. PCT/JP04/14336, filed on Sep. 30, 2004.

(51) Int. Cl. G09G 3/36

(52) U.S. Cl. 345/98

(57) ABSTRACT

In a liquid crystal display device, halftones are displayed by applying voltages to liquid crystal elements so that the transmittance of liquid crystals is changed. A plurality of gradation-reference-voltage-generation circuits are provided as sources for generating the voltages to be applied to the liquid crystals to realize display of the halftones. With this configuration, gradation-reference voltages for γ characteristics for display colors are generated, and furthermore, applied voltages for the display colors are generated on the basis of the generated gradation-reference voltages. This allows for gradation display for each of the display colors, resulting in excellent image display.

### BACKGROUND OF THE INVENTION

1. Field of the Invention

The present invention relates to a method for driving liquid crystal display devices and to liquid crystal display devices. More particularly, the present invention relates to a liquid crystal display device utilizing a Ferroelectric Liquid Crystal (FLC) or an Anti-Ferroelectric Liquid Crystal (AFLC) having spontaneous polarization.

2. Description of the Related Art

In general, known TN (Twisted Nematic) liquid crystals have a response speed of 10 to several dozen ms when a voltage is applied. The smaller an applied voltage difference, the longer the rise time in which transmittance of liquid crystal elements rises from 0% to 95% after the voltage is applied. In this case, the rise time may be nearly 100 ms (refer to Patent Document 1). Accordingly, when halftone display having different levels is performed, the response speed is markedly reduced. Thus, when 60 images per second are displayed as a moving image on a liquid crystal display device utilizing a TN liquid crystal, liquid crystal molecules do not activate completely, resulting in blurred images. The TN liquid crystal is not suitable for display of moving images such as multimedia.

Since liquid crystal material has wavelength dependence, each display color has a different γ characteristic curve. Accordingly, even though a gradation is intended to be displayed in a monochrome image on the liquid crystal display device, colors can be seen a little in the gradation. Furthermore, in a conventional liquid crystal display device, a white cold cathode fluorescent lamp is provided on the back side of the liquid crystal panel, and color filters for corresponding RGB color components are provided on the liquid crystal elements on the front side of the liquid crystal panel. With this configuration, when a voltage is applied to each of the liquid crystal elements, the transmittance of the liquid crystal element is changed and a color display by means of mixture of three primary colors is performed.

In accordance with the wavelength dependence of the liquid crystal material used, a color filter characteristic, and the range of human vision, γ correction should be performed for each of the RGB color components. In the conventional liquid crystal display device, the number of voltages to be applied to liquid crystal pixels in accordance with gradation is set to approximately four times the number of gradation levels of input image data, whereby the display data is corrected so that γ characteristic curves for display colors are the same.

Referring to FIGS. 1 and 2, an example of a gradation display of a conventional liquid crystal display device will be described in detail. In FIG. 1, voltages V0 and V8 are applied from an LCD-power-supply circuit, which is not shown, to a gradation-reference-voltage-generation circuit 200. Resistors R1 to R8 connected in series divide the voltages V0, V1, . . . , V7, and V8 and the divided voltages are used as gradation-reference voltages to be applied to liquid crystal elements. The gradation-reference voltages V0 to V8 generated in the gradation-reference-voltage-generation circuit 200 are further divided by means of a gradation-voltage-generation circuit 220 in a source driver 210. Thus, the number of gradation voltages applied to each of the liquid crystal elements is 64.

Such a conventional liquid crystal display device has only one type of gradation voltage. As described above, display data is converted in an LUT 230 for each γ characteristic for corresponding RGB color component and the converted data is held in a data-latching circuit 240. Then, the held data is subjected to D/A conversion and amplified. in a D/A converter-and-amplifier 250, and thereafter converted to an analog voltage in accordance with a reference voltage in a corresponding level supplied from the gradation voltage circuit. The converted analog voltage is transmitted to each of pixels 001(R), 001(G), 001(B), . . . , 800(R), 800(G), 800(B) at a predetermined timing. A group of the three pixels 001(R), 001(G), 001(B) denoted by a reference numeral 260 constitutes a display pixel and all pixels denoted by a reference numeral 270 constitute a line of display pixels.

The LUT 230 will be described in detail with reference to FIG. 2. FIG. 2 illustrates the relationship between an input gradation and an output voltage. The axis of abscissa denotes the input gradation corresponding to gradation data for a certain color in image data. The axis of ordinate denotes the output voltage applied from the source driver 210 to liquid crystal elements in accordance with the input gradation.

In FIG. 2, a γ characteristic indicated by black circles illustrates the relationship between gradation voltages generated in the gradation voltage generation circuit 220 and gradation data. As described above, the γ characteristic indicated by the black circles should be corrected for each RGB color component in accordance with the wavelength dependence of the liquid crystal material used, a color filter characteristic, and the range of human vision. As shown by squares in FIG. 2, the LUT 230 converts gradation data n of image data into gradation data n′ and gradation data m into gradation data m′, for example, to obtain a preferable γ characteristic for green.

As described above, in the conventional liquid crystal display device, the source driver 210 generates a number of gradation voltages corresponding to approximately four times the number of gradation levels displayed on a liquid crystal panel so that preferable characteristics for corresponding colors can be obtained. The number of gradation voltages should be increased in order to obtain a preferable γ characteristic for each of the colors more accurately. That is, when image data is corrected for correction of the γ characteristic for each display color, even if the number of the gradation voltages is large, the number of gradation levels which are in the visible range is reduced.

As for generation of the gradation voltages described above, it is known that, in a circuit corresponding to the gradation-reference-voltage-generation circuit 200 shown in FIG. 1, a γ characteristic is corrected for ratio of divided voltages by resistance in accordance with data stored in a nonvolatile memory in advance by means of a γ correction control circuit constituted by constant current sources, a resistor, and a buffer amplifier (refer to Patent Document 2). When γ characteristics are significantly different between colors such as between blue and green, color reproducibility is not necessarily good.

Patent Document 1: Japanese Patent Unexamined Publication Application No. 1994-102486

Patent Document 2: Japanese Patent Unexamined Publication Application No. 2003-280615

### SUMMARY OF THE INVENTION

The TN liquid crystal described above has following drawbacks. The TN liquid crystal takes time to be activated, and furthermore, use of color filters for corresponding RGB color components degrades transmittance. Since only one type of gradation reference voltage is used for correction of γ characteristics for corresponding colors and voltages applied to liquid crystals are generated in accordance with gradation data, chromatic purity is deteriorated.

As a measure of the drawback in which the TN liquid crystal takes time to be activated, a liquid crystal display device utilizing an FLC or an AFLC which has a high response speed of several dozen to several hundred μs when a voltage is applied has been put into practical use. Each of the FLC and AFLC is liquid crystal material having spontaneous polarization. Each of these liquid crystal materials capable of high-speed response is used in the liquid crystal display device, a voltage applied to each pixel is controlled by means of a switching element such as a TFT (thin film transistor) or an MIM (metal insulator metal), and liquid crystal molecules are completely polarized in a short period of time. In this way, a liquid crystal display device which is capable of excellent display of moving images, which is capable of generating gradation reference voltages and gradation voltages for corresponding display colors by a time-division color method by means of backlight which emits red, green, and blue in a time-division manner by using an LED light source in stead of by means of white backlight, and which has significantly improved color reproducibility can be provided.

According to the present invention, there is provided a liquid crystal display device having liquid crystal elements, including a plurality of gradation-reference-voltage circuits for generating gradation-reference voltages to be applied to the liquid crystal elements in accordance with a plurality of gradation levels of a color of light emitted from the liquid crystal elements.

Furthermore, according to the present invention, there is provided the liquid crystal display device wherein the emitted light has a plurality of colors and the gradation-reference-voltage circuits generate gradation-reference voltages corresponding to the plurality of colors of the emitted light.

Furthermore, according to the present invention, there is provided a liquid crystal display device having liquid crystal elements, including a source driver having a digital-to-analog conversion circuit for converting display data, which is digital data input to the liquid crystal display device, into analog voltages to be applied to the liquid crystal elements, and a gradation-reference-voltage-generation unit for generating a plurality of groups of the analog voltages used for converting the display data into the corresponding analog voltages by means of the digital-to-analog conversion circuit. The source driver converts the digital data into analog voltages for display colors included in the display data in accordance with one of the plurality of groups of analog voltages.

Furthermore, according to the present invention, there is provided a liquid crystal display device having liquid crystal elements, including a source driver having a digital-to-analog conversion circuit for converting display data, which is digital data input to the liquid crystal display device, into analog voltages to be applied to the liquid crystal elements, a gradation-reference-voltage-generation unit for generating a plurality of groups of the analog voltages used for converting the display data into the corresponding analog voltages by means of the digital-to-analog conversion circuit, and a γ-correction circuit for correcting gradation of the display data. A group of the analog voltages based on gradation correction performed by means of the γ -correction circuit and each of display colors is selected in synchronization with display of the display colors corresponding to the display data on the liquid crystal element for corresponding display color data in the display data, and the display data is displayed.

Moreover, according to the present invention, there is provided a liquid crystal display device having liquid crystal elements, including a source driver having a digital-to-analog conversion circuit for converting display data, which is digital data input to the liquid crystal display device, into analog voltages to be applied to the liquid crystal elements, a gradation-reference-voltage-generation unit for generating a plurality of groups of the analog voltages used for converting the display data into corresponding analog voltages by means of the digital-to-analog conversion circuit, a γ-correction circuit for correcting gradation of the display data, and a backlight capable of switching a color of emitted light among a plurality of colors of emitted light and disposed on a rear side of the liquid crystal elements. A group of the analog voltages for the corresponding display color is selected in accordance with display color data in the display data, and luminance of emitted light from the backlight is controlled.

Moreover; according to the liquid crystal display device, in a gradation-reference-voltage-generation circuit for generating reference voltages for gradation display required for digital-to-analog conversion of display data by an LCD-source-driver IC which is a source driver in the liquid crystal display device configured as an integrated circuit, the gradation-reference-voltage-generation circuit which generates at least two types of group of gradation-reference voltages to be supplied to the LCD source driver IC and switches between the groups of the gradation-reference voltages for colors in synchronization with corresponding display colors, and a γ-correction circuit for correcting gradation of display data input to a display device are provided. The gradation-reference-voltage-generation circuit and the γ-correction circuit are used in cooperation with each other in synchronization with each of the display colors, and a group of the voltages output from the gradation-reference-voltage-generation circuit and a correction method used in the γ-correction circuit are changed for each of the display colors.

Moreover, according to a liquid crystal display device, in a gradation-reference-voltage-generation circuit for generating reference voltages for gradation display required for digital-to-analog conversion of display data by an LCD-source-driver IC which is a source driver in the liquid crystal display device configured as an integrated circuit, the gradation-reference-voltage-generation circuit which generates at least two types of group of gradation-reference voltages to be supplied to the LCD source driver IC and switches between the groups of the gradation-reference voltages for colors in synchronization with corresponding display colors, a γ-correction circuit for correcting gradation of display data input to a display device, and a backlight-control circuit for controlling, for each of the display colors, emission luminance from a backlight disposed on a rear side of the liquid crystal elements are provided. The gradation-reference-voltage-generation circuit, the γ-correction circuit, and the backlight-control circuit are used in cooperation with one another in synchronization with each of the display colors, and a group of the voltages output from the gradation-reference-voltage-generation circuit, a correction method used in the γ-correction circuit, and luminance of emitted light from the backlight controlled by the backlight-control circuit are changed for each of the display colors.

### BRIEF DESCRIPTION OF THE DRAWINGS

FIG. 1 is a diagram showing a known example of a source driver and a gradation-reference-voltage-generation circuit of liquid crystals.

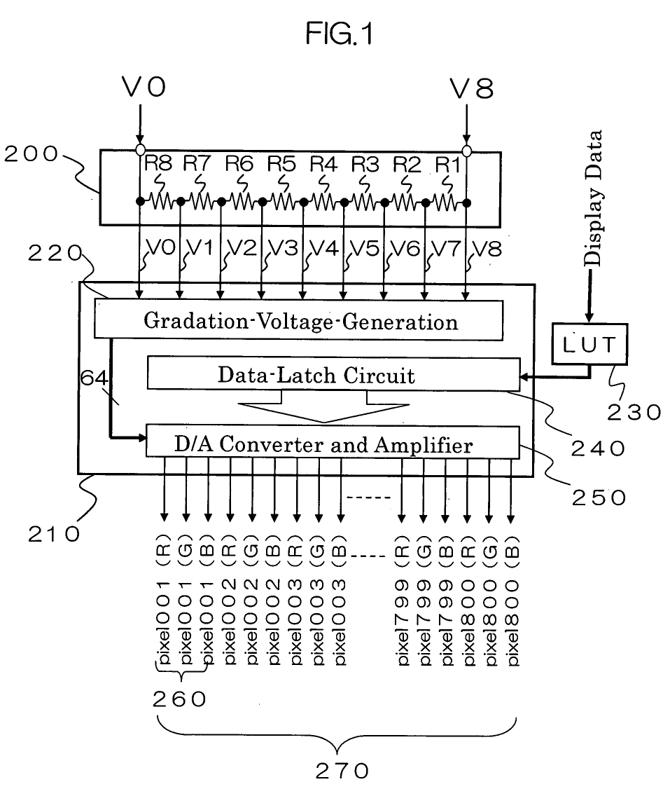

FIG. 2 is a graph showing an example of γ correction.

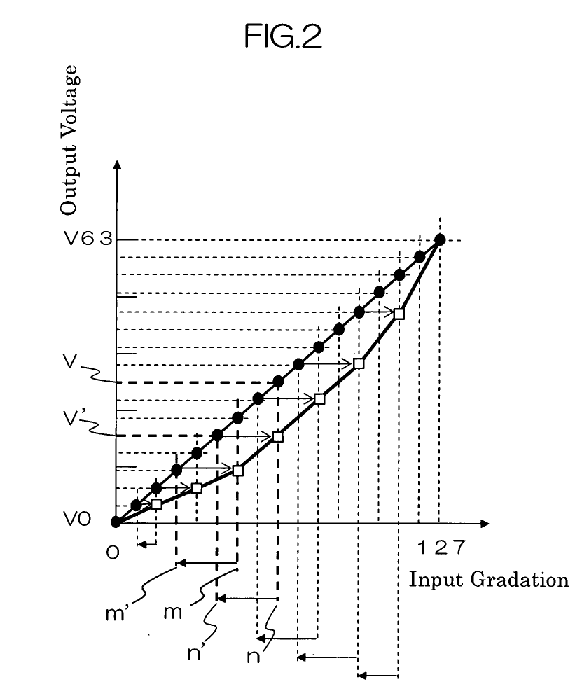

FIG. 3 is a block diagram schematically showing a configuration of a liquid crystal display device of the present invention.

FIG. 4 is a schematic sectional view of a liquid crystal panel used in the present invention.

FIG. 5 is a schematic perspective view showing a configuration example of a liquid crystal panel, a backlight, and a polarizing plate used in the present invention.

FIG. 6 is a schematic plan view of a configuration of a rear-glass substrate of the liquid crystal panel in the liquid crystal display device of the present invention.

FIG. 7 is a schematic diagram showing the source driver and the gradation-reference-voltage-generation circuit of the present invention.

FIG. 8 is an example of a display characteristic according to the present invention.

FIG. 9 is another example of a display characteristic according to the present invention.

FIG. 10 is a further example of a display characteristic according to the present invention.

FIG. 11 is a diagram showing an example of a circuit configuration of a second embodiment of the present invention.

FIG. 12 includes FIG. 12A illustrating a diagram showing a display characteristic according to the second embodiment of the present invention, FIG. 12B illustrating a diagram showing another display characteristic according to the second embodiment of the present invention, FIG. 12C illustrating a diagram showing still another display characteristic according to the second embodiment of the present invention, and FIG. 12D illustrating a diagram showing a further display characteristic according to the second embodiment of the present invention.

FIG. 13 is a diagram showing a circuit configuration of a third embodiment of the present invention.

FIG. 14 includes FIG. 14A illustrating a diagram showing a display characteristic according to the third embodiment of the present invention, FIG. 14B illustrating a diagram showing another display characteristic according to the third embodiment of the present invention, FIG. 14C illustrating a diagram showing still another display characteristic according to the third embodiment of the present invention, and FIG. 14D illustrating a diagram showing a further display characteristic according to the third embodiment of the present invention.

FIG. 15 is a diagram showing a configuration example when a′ digital potentiometer is employed for the gradation-reference-voltage-generation circuit of the present invention.

FIG. 16 is a diagram showing a configuration example of the digital potentiometer.

FIG. 17 is a view of an example of a mobile terminal on which the liquid crystal display device of the present invention is mounted.

### DESCRIPTION OF THE PREFERRED EMBODIMENT

The present invention is described in detail on the basis of the drawings illustrating embodiments of the present invention.

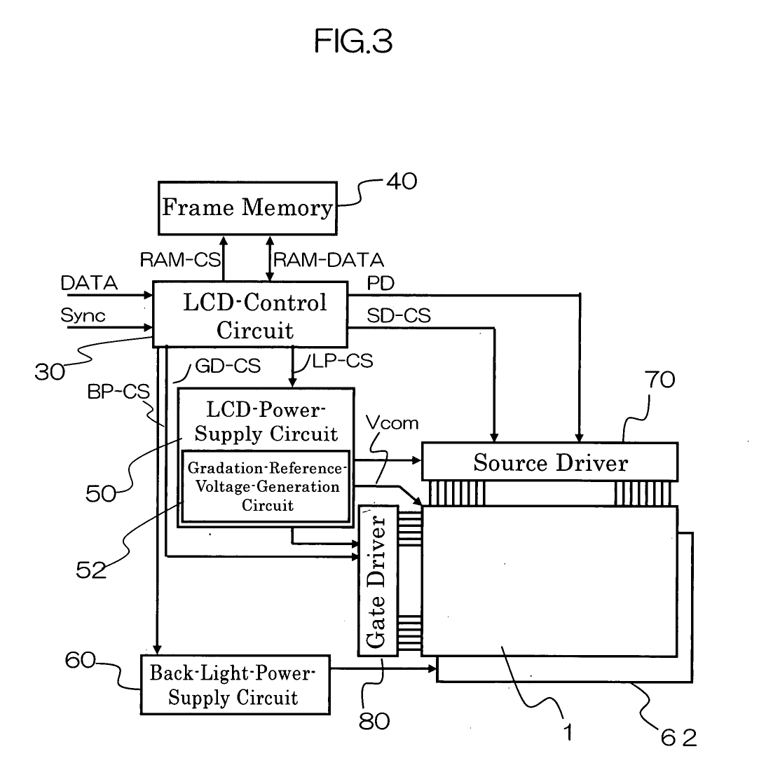

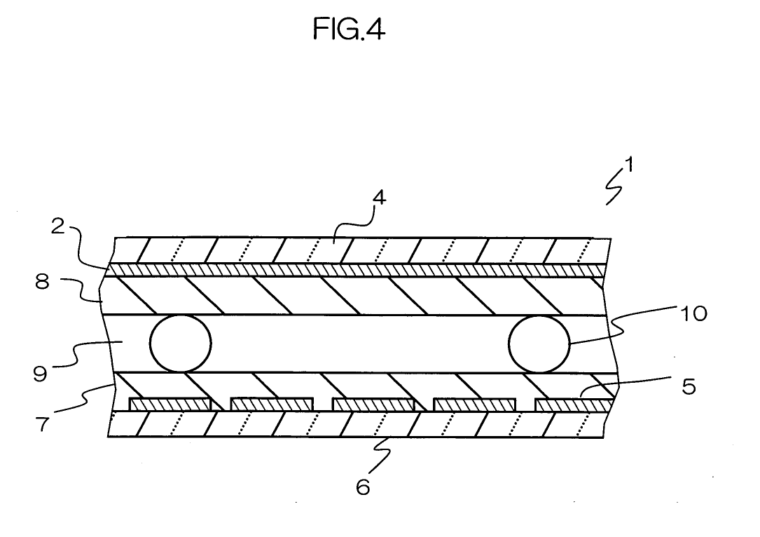

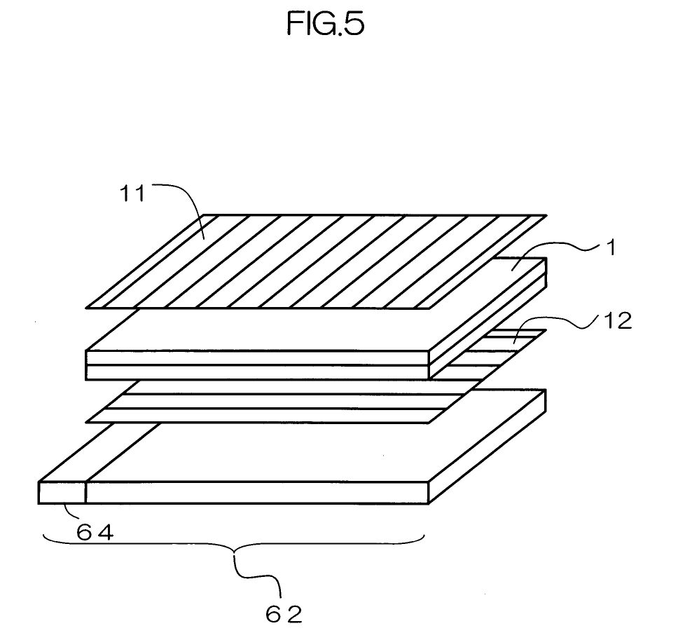

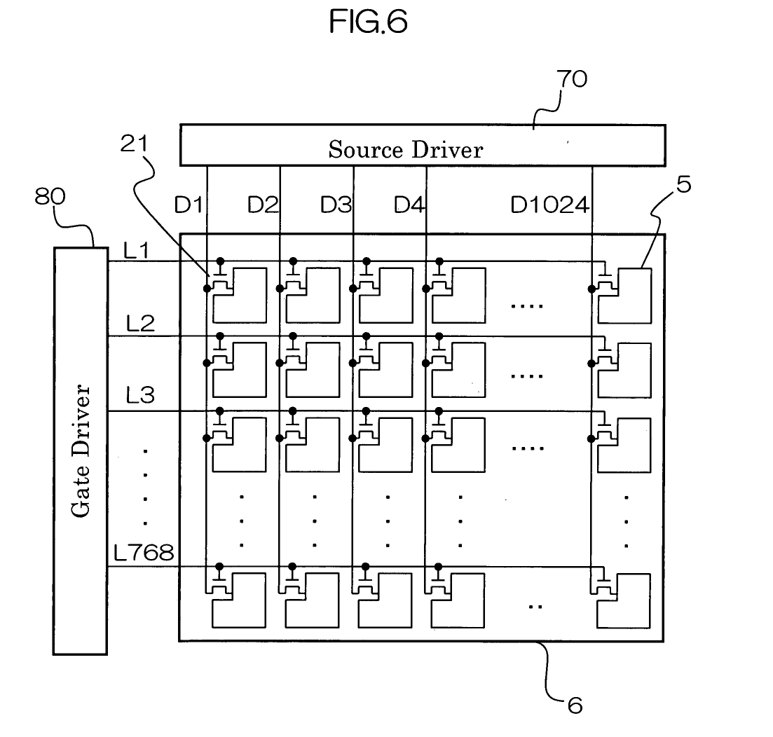

FIG. 3 is a diagram showing a schematic block configuration of a liquid crystal display device according to the present invention. FIG. 4 is a schematic sectional view of a liquid crystal panel used in the present invention. FIG. 5 is a view schematically showing a configuration example of a liquid crystal panel, a backlight, and a polarizing plate used in the present invention. FIG. 6 is a plan view schematically showing a configuration of a rear-glass substrate of the liquid crystal panel in the liquid crystal display device of the present invention.

Note that the present invention is not limited to the embodiments which will be described hereinafter.

### First Embodiment

FIG. 3 is a diagram showing a schematic block configuration of a liquid crystal display device of the present invention. A liquid crystal panel 1 shown in FIG. 3 has pixel electrodes 5 and TFTs 21 arranged in a matrix of 1024 rows and 768 columns, that is 1024×768 in total, on a rear-glass substrate 6, as the configuration shown in FIG. 6 in detail. The pixel electrodes 5 are connected to corresponding drain terminals of the TFTs 21. Gate terminals of the TFTs 21 are connected to corresponding scanning lines Li (i=1, 2, 3, . . . , 768) of a gate driver 80 and source terminals of the TFTs 21 are connected to corresponding data lines Dj (j=1, 2, 3, . . . , 1024) of a source driver 70.

Scanning signals are supplied from the gate driver 80 to be input to the scanning lines Li line by line, whereby the TFTs 21 having the gate terminals connected to the scanning lines Li are controlled to turn on and off. When the TFTs 21 are turned on, data voltages input to the corresponding data lines Dj from the source driver 70 are applied to the pixel electrodes 5. When the TFTs 21 are turned off, data voltages are held by capacitative elements (not shown) or the like. In accordance with the data voltages applied through the TFTs 21, the light transmittance of a liquid crystal determined by a V-T characteristic which is an electrooptic characteristic of a liquid crystal indicating the relationship between an applied voltage and the transmittance of a liquid crystal element is controlled and an image is displayed.

The liquid crystal display device according to this embodiment has, in addition to the source driver 70 and the gate driver 80 described above, peripheral circuits including an LCD-control circuit 30, a frame memory 40, an LCD-power-supply circuit 50, and a backlight-power-supply circuit 60, as shown in FIG. 3.

The LCD-control circuit 30 receives image data DATA and a synchronizing signal Sync from a higher-level apparatus such as a personal computer. Furthermore, the LCD-control circuit 30 generates a RAM-control signal RAM-CS for controlling an input/output timing for writing/reading the display data DATA in/from the frame memory 40, a control signal SD-CS required for controlling an operation of the source driver 70, a control signal GD-CS required for controlling an operation of the gate driver 80, a control signal LP-CS required for controlling the LCD-power-supply circuit 50, and a control signal BP-CS required for controlling the backlight-power-supply circuit 60. Then, the control signals RAM-CS, SD-CS, GD-CS, LP-CS, and BP-CS generated as described above are output to the frame memory 40, the source driver 70, the gate driver 80, the LCD-power-supply circuit 50, and the backlight-power-supply circuit 60, respectively.

The LCD-control circuit 30 writes the input display data DATA in synchronization with the input synchronizing signal Sync, stores the data in the frame memory 40, acquires the display data DATA to be displayed on the liquid crystal panel 1 from the frame memory 40, and outputs the display data DATA as image data PD to the source driver 70.

The synchronizing signal Sync and display data DATA input to the LCD-control circuit 30 may be a signal that is obtained after A/D conversion of a CRT output signal from a personal computer, a signal restored by a DVI (Digital Video Interface) receiver IC or a DVI signal, a signal restored by an LVDS (Low Voltage Differential Signaling) receiver IC or an LVDS signal, a signal generated by a dedicated PCI (Peripheral Component Interconnect) card, an LCD signal output from an LCD control IC or a CPU employed in a PDA (Personal Digital Assistant) or a cellular phone, or a signal obtained by directly controlling a video RAM in an apparatus such as a PDA or a PC by means of the LCD-control circuit.

The frame memory 40 stores the display data DATA acquired by the LCD-control circuit 30 in synchronization with the control signal RAM-CS generated in the LCD-control circuit 30, and inputs/outputs the stored display data DATA to/from the LCD-control circuit 30 as RAM-DATA.

The LCD-power-supply circuit 50 generates, in synchronization with the control signal LP-CS generated in the LCD-control circuit 30, a driving voltage for the source driver 70, a driving voltage for the gate driver 80, and a voltage Vcom to be applied to a counter electrode 2 (refer to FIG. 4) of the liquid crystal panel 1, and outputs the generated voltages as the driving voltage for the source driver 70, as the driving voltage for the gate driver 80, and as the voltage for the counter electrode 2 of the liquid crystal panel 1, correspondingly.

The backlight-power-supply circuit 60 generates, in synchronization with the control signal BP-CS generated in the LCD-control circuit 30, a voltage for turning on the backlight and performs on/off control for the backlight.

The source driver 70 acquires, in synchronization with the control signal SD-CS generated in the LCD-control circuit 30, the image data PD output from the LCD-control circuit 30 and applies voltages in accordance with the image data PD to the data lines Dj in the liquid crystal panel 1.

The gate driver 80 sequentially applies, in synchronization with the control signal GD-CS generated in the LCD-control circuit 30, on/off control voltages to the scanning lines Li line by line.

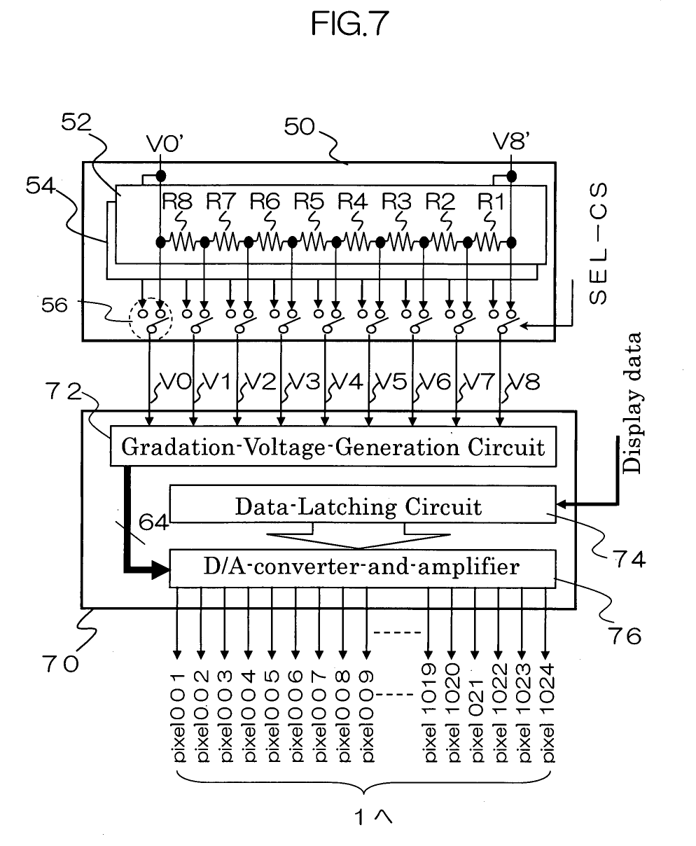

In FIG. 7, for driving voltages for the source driver, an example of the LCD-power-supply circuit 50 having a plurality of gradation-reference-voltage-generation circuits 52 and 54 is shown. At least two gradation-reference-voltage-generation circuits 52 and 54 are used, and each of the gradation-reference-voltage-generation circuits 52 and 54 has a different group of gradation-reference voltages “V0, V1, . . . , V8” generated in the corresponding gradation-reference-voltage-generation circuits 52 and 54. The generated gradation-reference voltages “V0, V1, . . . , V8” are switched by switches 56 controlled by a selection signal SEL-CS supplied from the LCD-control circuit 30 for each display color. Although the two types of gradation-reference-voltage-generation circuit are shown in FIG. 7, three types of group of gradation-reference voltages “V0, V1, . . . , V8” may be generated for RGB color components. Alternatively, the gradation-reference voltages may be further divided to generate gradation-reference voltages “V0, V1, . . . , V8, V9, . . . , V15, V16”, for example.

A gradation-voltage-generation circuit 72 in the source driver 70 generates gradation voltages for all gradation data on the basis of the gradation-reference voltages “V0, V1, . . . , V8” input externally and generated in the gradation-reference-voltage-generation circuits 52 and 54. The voltages generated in the gradation-voltage-generation circuit 72 are output through a D/A-converter-and-amplifier-stage circuit to pixels as gradation voltages.

Note that in a case where two types of gradation-reference-voltage-generation circuit are used, for example, gradation voltages for red and green are generated in an identical gradation-reference-voltage-generation circuit, and a gradation voltage for blue is generated in another gradation-reference-voltage-generation circuit. Thereafter, display data may be corrected for red and green. In this way, even if two types of gradation-reference-voltage-generation circuit are used, only a small amount of correction is required. Accordingly, color reproducibility is improved compared with that obtained in the related art.

Referring to FIG. 4, the liquid crystal panel 1 of the present invention will be described. The liquid crystal panel 1 includes the pixel electrodes 5 arranged in a matrix on the rear-glass substrate 6, made of ITO (Indium Tin Oxide), and having excellent light transmittance. The liquid crystal panel 1 further includes TFTs (not shown) connected to the corresponding pixel electrodes 5. The pixel electrodes and the TFTs are covered with an alignment layer 7.

The counter electrode 2, which is a transparent electrode made of ITO, and an alignment layer 8 is arranged on a front-glass substrate 4. The alignment layer 7 and the alignment layer 8 are arranged on the pixel electrodes 5 and the counter electrode 2, respectively. The front-glass substrates and the rear-glass substrate 6 are arranged so as to face the alignment layer 7 and the alignment layer 8, respectively. Spacers 10 are spread between the alignment layer 7 and the alignment layer 8 for maintaining a gap (1.6 μm, for example) which is uniform between the alignment layer 7 and the alignment layer 8. The gap between the alignment layer 7 and the alignment layer 8 is filled with an FLC to form a liquid crystal layer 9. In this embodiment, each of the pixel electrodes 5 arranged in a matrix on the rear-glass substrate 6 has a size of 0.24 mm×0.24 mm, and a liquid crystal panel having 1024 pixels in the horizontal direction and 768 pixels in the vertical direction, and having a size of 12.1 inches diagonally is used as an example.

As shown in FIG. 5, the liquid crystal panel 1 is sandwiched by polarizing plates 11 and 12 and a backlight 62 is arranged on the rear-glass substrate 6 side. The backlight 62 has at one end thereof a light source 64 having an LED array which selectively allows each of red, green, and blue light to be emitted from a plane as a single color. The backlight 62 has a scattering plate for introducing emission light from the light source 64 and for scattering the emission light toward the rear-glass substrate 6.

FIG. 6 is a schematic plan view showing the liquid crystal panel of the liquid crystal display device according to the first embodiment of the present invention. The pixel electrodes 5 and the TFTs 21 are arranged on the rear-glass substrate 6 in a matrix (1024 in the horizontal direction and 768 in the vertical direction, that is, 1024×768 in total). The pixel electrodes 5 are connected to the corresponding drain terminals of the TFTs 21. The gate terminals of the TFTs 21 are connected to the scanning lines Li (i=1, 2, 3, . . . , 768) of the gate driver 80, and the source terminals of the TFTs 21 are connected to the data lines Dj (j=1, 2, 3, . . . , 1024) of the source driver 70. The scanning lines Li are connected to the corresponding. output stages of the gate driver 80, and the data lines Dj are connected to the corresponding output stages of the source driver 70.

The TFTs 21 are controlled to be turned on and off by inputting the scanning signals sequentially supplied from the gate driver 80 to the scanning lines Li. Each of the TFTs 21 applies data voltages, which is supplied from the source driver 70 to the data lines Dj, to the pixel electrodes 5 during an on-period, whereas the TFTs hold the received data voltage during an off-period. The light transmittance of a liquid crystal determined by the V-T characteristic (applied voltage-transmittance characteristic), which is an electrooptic characteristic of the liquid crystal, is controlled by the data voltages applied through the TFTs 21 for display of an image.

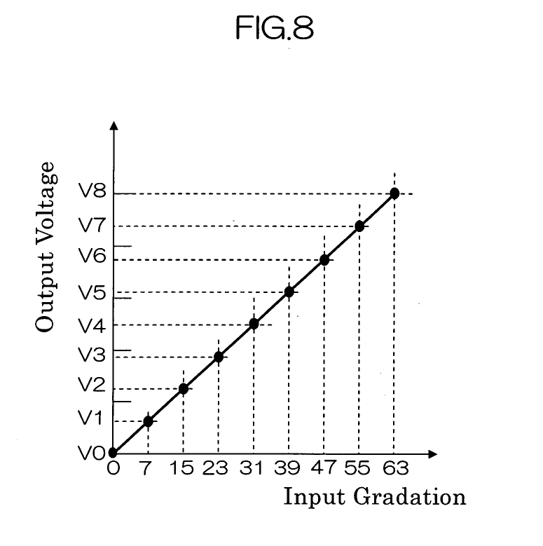

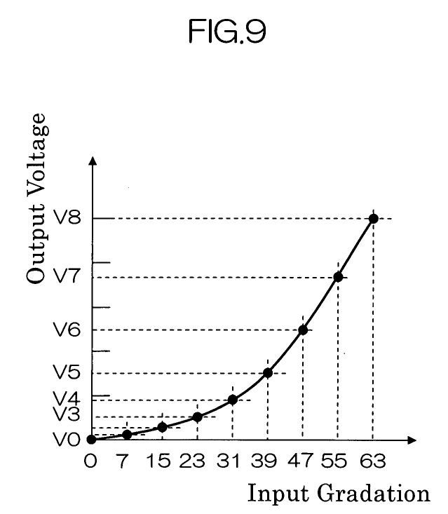

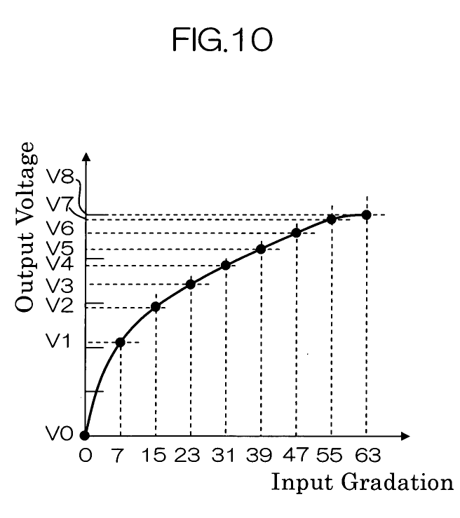

According to the first embodiment of the present invention described above, in FIGS. 8, 9, and 10, the axis of abscissa indicates input gradation of image data and the axis of ordinate indicates a characteristic of an output voltage to be applied to liquid crystal elements from the source driver 70 for colors of red, green, and blue, respectively. As shown in the figures, an image can be displayed with a preferable γ characteristic for each display color. Furthermore, the γ characteristic can be corrected without reducing gradation levels realized by the source driver 70. The black circles in the figures show the gradation-reference voltages “V0, V1, . . . , V8”.

According to the present invention, the γ characteristic can be corrected for each of the display colors, resulting in an excellent display characteristic. The liquid crystal display device of the present invention is applicable to any display device such as a liquid crystal display for a desktop computer, a liquid crystal display mounted on a laptop PC, a liquid crystal display mounted on a PDA or a cellular phone, a liquid crystal display mounted on a game device, and a liquid crystal display for a home television set or a portable television set. The liquid crystal display device is further applicable to display devices such as a video camera or a digital camera having a viewfinder or a monitor directly viewed by a user, a car navigation device, and a POS (Point Of Sales) terminal.

In the foregoing description, the source driver is illustrated using a plurality of functional blocks. The source driver configured as an IC is advantageous in terms of reliability and miniaturization.

Although the gradation-reference voltages are shown as V0, V1, . . . , V8 in FIG. 7, the gradation-reference voltages can be further divided to obtain more gradation-reference voltages. Moreover, the gradation-reference voltages are further divided to obtain 64 gradation levels including V0.

According to the first embodiment, the liquid crystal display device has two or more types of group of gradation-reference voltages supplied to the source driver. The groups of the reference voltages for gradation display are switched for corresponding colors in synchronization with display colors. Accordingly, a γ characteristic curve can be changed for each of the display colors.

### Second Embodiment

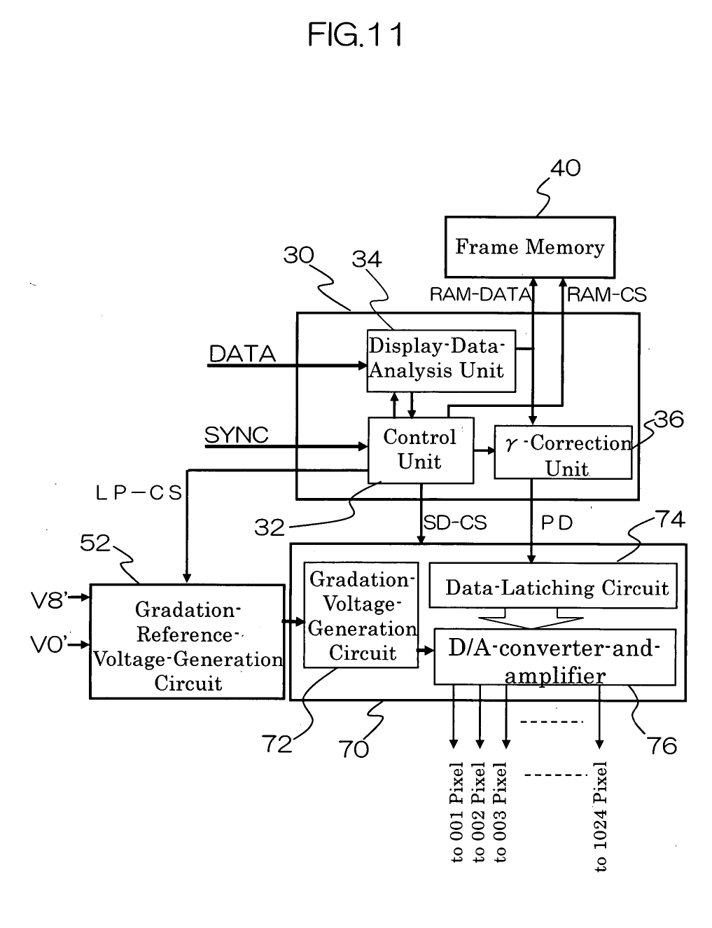

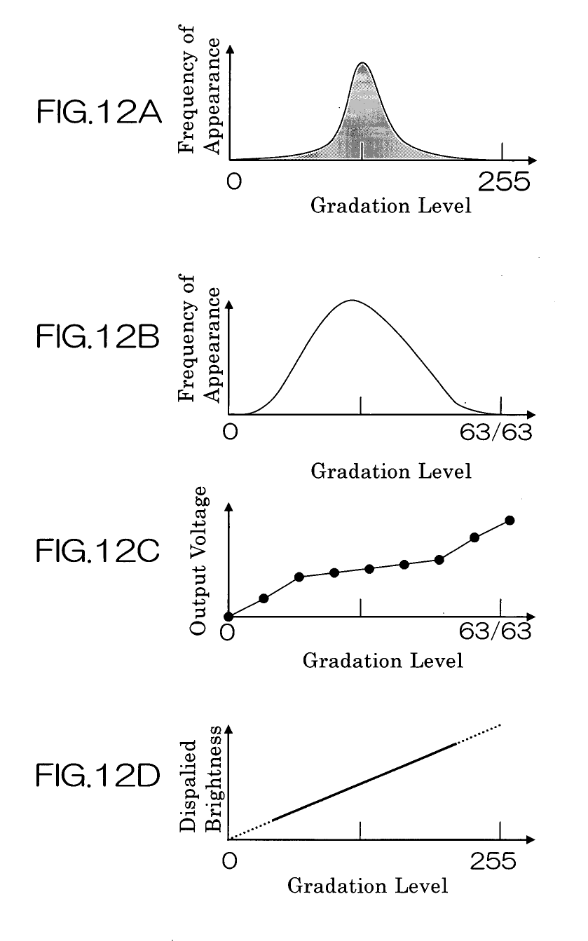

A second embodiment of the present invention will now be described with reference to FIG. 11 and FIGS. 12A to 12D. In FIG. 11 showing the second embodiment, the same function parts as those in the first embodiment are denoted by the same reference numerals.

In the second embodiment, the configuration is substantially similar to that of the first embodiment, but is different in an internal configuration of an LCD-control circuit 30. In FIG. 11, display data DATA is stored in a frame memory 40 through a display-data-analysis unit 34 disposed in the LCD-control circuit 30. As shown in FIG. 12A, the display-data-analysis unit 34 analyzes the frequency of appearance of gradation levels for each color of the display data in a single frame. The result of the analysis is transmitted to a control unit 32 in the LCD-control circuit 30. When the display data stored in the frame memory 40 is read out, a y-correction unit 36 and a gradation-reference-voltage-generation circuit 52 are controlled as shown in FIGS. 12B and 12C so that gradation levels having a low frequency of appearance are omitted and gradation levels having a high frequency of appearance can be displayed. In this way, the gradation levels having a high frequency of appearance can be mainly displayed as shown in FIG. 12D.

The display-data-analysis unit 34 analyzes the number of pixels in gradation levels of 0 to 255 in the single frame for each of the display colors in the image data DATA, and further analyzes the relationship between the gradation levels and frequency of appearance for each of the display colors as shown in FIG. 12A. Setting a maximum distribution portion as a center, a γ-correction unit 36 performs γ correction so that gradation levels of 0 to 63 are set to the maximum distribution portion and its vicinity. Meanwhile, to generate gradation voltages having the gradation levels of 0 to 63 to the maximum distribution portion and its vicinity analyzed by the display-data-analysis unit 34, the control unit 32 transmits a control signal LP-CS to the gradation-voltage-generation circuit 52, and the gradation-voltage-generation circuit 72 generates gradation voltages having a gradation-to-output voltage characteristic indicating a γ characteristic shown in FIG. 12C. Accordingly, an image mainly having a gradation level which has a high frequency of appearance and its vicinity as shown in FIG. 12D is displayed on a liquid crystal display device. Here, although the single gradation-reference-voltage-generation circuit 52 is used in FIG. 11, a plurality of types of gradation-reference-voltage-generation circuit can be used as shown in the first embodiment.

The operation described above is performed for each of the display colors. Accordingly, the number of gradation levels larger than the gradation levels realized by the source driver 70 can be obtained for liquid crystal elements, whereby a color display device realizing color display with smooth gradation can be obtained.

Such a display device having an excellent display characteristic is applicable to any display device such as a liquid crystal display for a desktop computer, a liquid crystal display mounted on a laptop PC, a liquid crystal display mounted on a PDA or a cellular phone, a liquid crystal display mounted on a game device, and a liquid crystal display for a home television set or a portable television set. The liquid crystal display device is further applicable to display devices such as a video camera or a digital camera having a viewfinder or a monitor directly viewed by a user, a car navigation device, and a POS terminal.

According to the second embodiment, since a group of the gradation-reference voltages supplied to the LCD source driver and a γ-correction circuit for correcting gradation of display data input to a liquid crystal display device are used in cooperation with each other, gradation levels having a low frequency of appearance in the display data are omitted and gradation levels having a high frequency of appearance are displayed. Accordingly, even when an LCD source driver realizing a small number of gradation levels is used, high-gradation display can be achieved.

### Third Embodiment

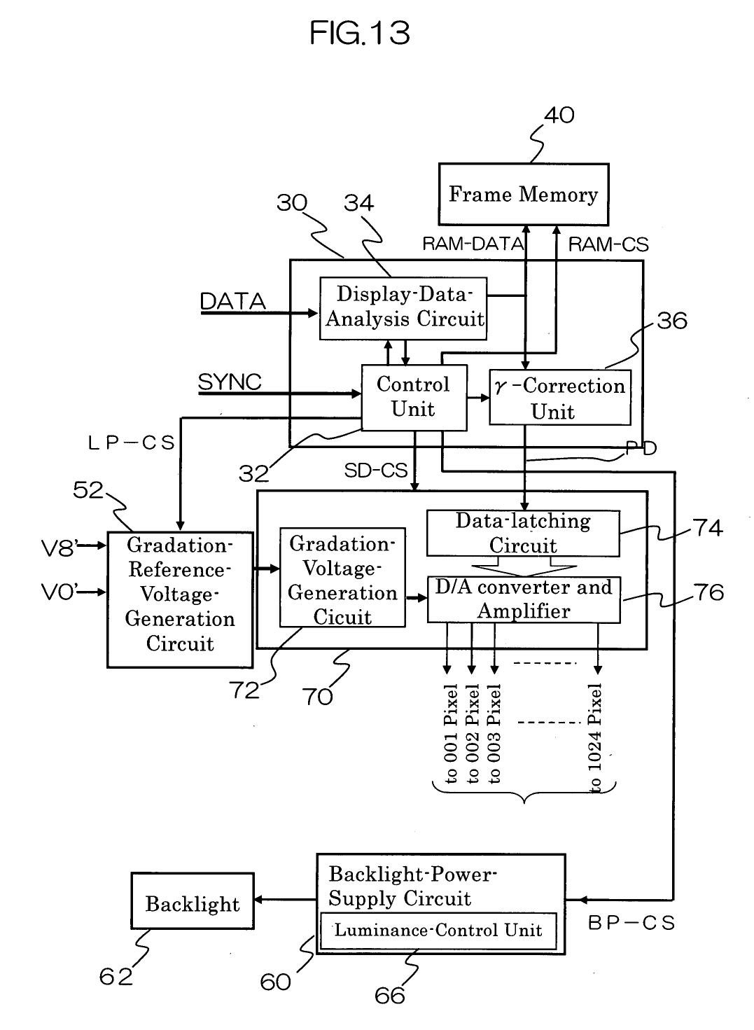

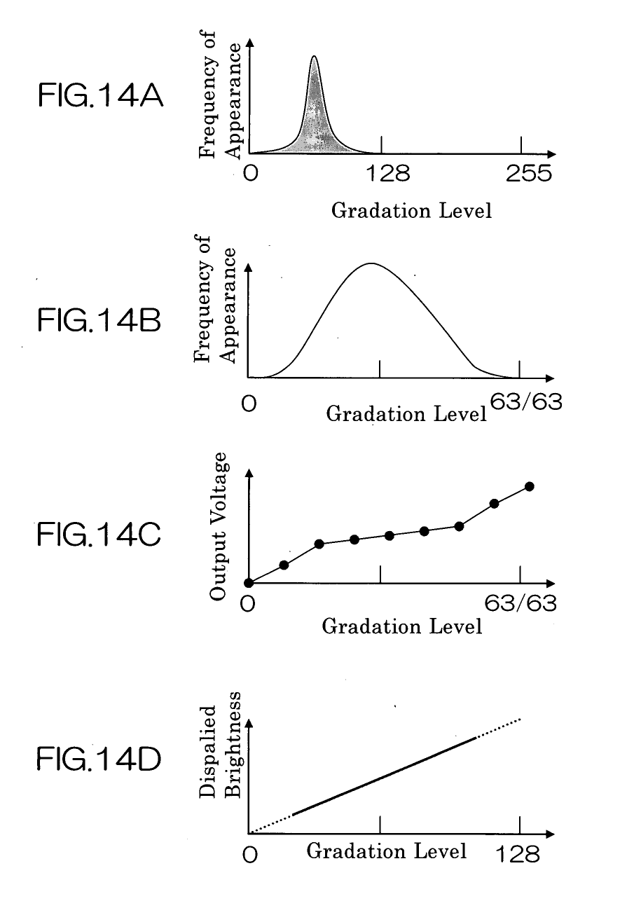

Referring to FIG. 13 and FIGS. 14A to 14D, a third embodiment of the present invention will be described. In FIG. 13 illustrating the third embodiment, parts having the same functions as those in the first and second embodiments are denoted by the same reference numerals.

Display data DATA is stored in a frame memory 40 through a display-data-analysis circuit 34. As shown in FIG. 14A, the display-data-analysis circuit 34 analyzes the display data in a single frame for each display color to obtain a frequency of appearance for each gradation level and analyzes the number of gradation levels, which is the maximum number of gradation levels, in the display data. The result of the analysis is transmitted to the LCD control circuit 30, and the display data for each color stored in the frame memory 40 is read out. A γ-correction unit 36 converts the maximum number of gradation levels in the display data into the maximum number of gradation levels which can be realized by a source driver 70, and gradation levels having a low frequency of appearance are omitted so that gradation levels having a high frequency of appearance can be displayed. As shown in FIG. 14B, to display gradation levels for each color included in the image data in a single frame and gradation levels in the vicinity thereof, a gradation-reference voltage output from a gradation-reference-voltage-generation circuit 52 is processed using a control signal LP-CS supplied from the control unit 32, as shown in FIG. 14C. The control unit 32 controls a luminance-control unit 66 in a backlight-power-supply circuit 60 using a control signal BP-CS so that a current to the light source 64 (refer to FIG. 5) of a backlight 62 is controlled and the luminance of the backlight 62 is controlled so as to obtain a luminance proportional to the maximum number of gradation levels of the display data. In this way, gradation levels having a high frequency of appearance can be mainly displayed as shown in FIG. 14D. Here, although the single gradation-reference-voltage-generation circuit 52 is used in FIG. 13, a plurality of types of gradation-reference-voltage-generation circuit can be used as shown in the first embodiment.

The operation described above is performed for each of the display colors, whereby a color display device realizing color display with smooth gradation can be obtained.

Such a display device having an excellent display characteristic is applicable to any display device such as a liquid crystal display for a desktop computer, a liquid crystal display mounted on a laptop PC, a liquid crystal display mounted on a PDA or a cellular phone, a liquid crystal display mounted on a game device, and a liquid crystal display for a home television set or a portable television set. The liquid crystal display device is further applicable to display devices such as a video camera or a digital camera having a viewfinder or a monitor directly viewed by a user, a car navigation device, and a POS terminal.

According to the third embodiment, a group of the gradation-reference voltages supplied to the LCD source driver, a γ-correction circuit for correcting gradation of display data input to a liquid crystal display device, and a backlight control circuit for controlling luminance for each color emitted from a backlight are used in cooperation with one another. In this way, even when an LCD source driver realizing a small number of gradation levels is used, high-gradation display can be achieved.

### Fourth Embodiment

In the gradation-reference-voltage-generation circuit 52 according to the first to third embodiments, the gradation-reference voltages “V0, V1, . . . , V8” are generated by dividing a voltage by means of a fixed resistor. Note that use of an element capable of electrically varying a resistance thereof, such as a digital potentiometer, simplifies the gradation-reference-voltage-generation circuit 52. Similarly, in the source driver 70, use of the gradation-reference-voltage-generation circuit 52 in a gradation-voltage-generation circuit 72 simplifies the circuit.

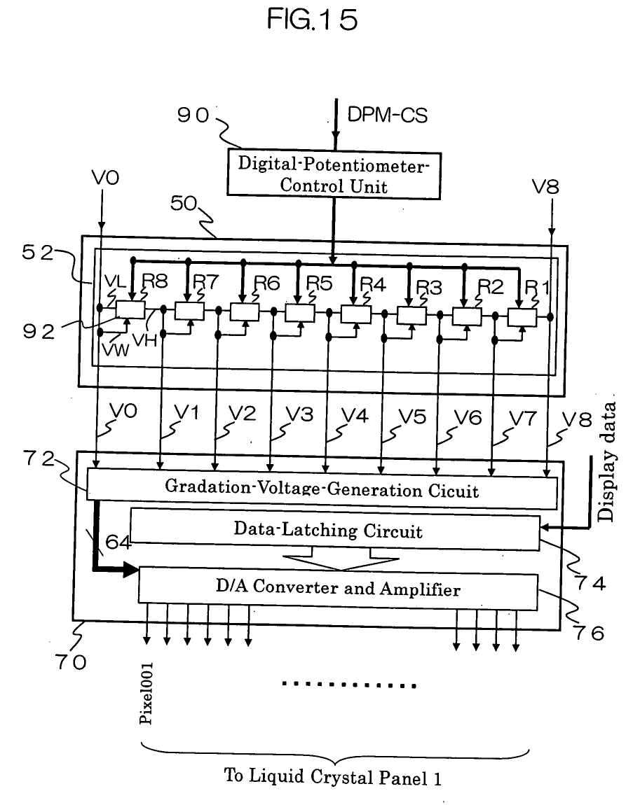

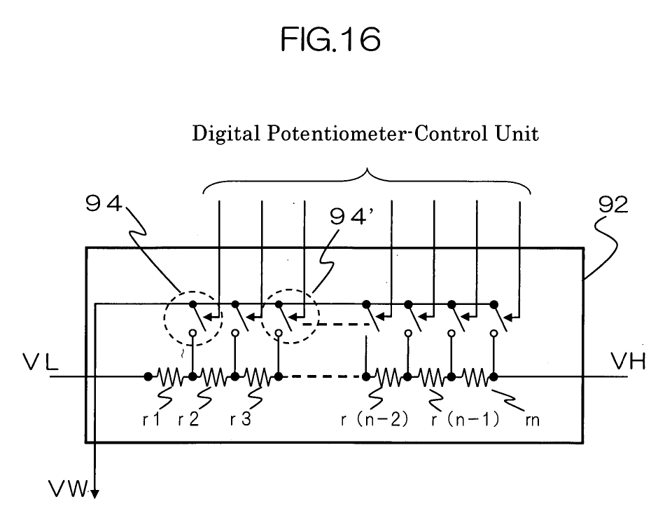

In FIG. 15, a plurality of digital potentiometers 92 are used in the gradation-reference-voltage-generation circuit 52 in the LCD-power-supply circuit, and generate gradation-reference voltages V0, V1, V2, . . . , V8. A digital-potentiometer-control unit 90 receives a digital-potentiometer-control signal DPM-CS supplied from an LCD control circuit (refer to FIG. 3), which is not shown. In accordance with the digital-potentiometer-control signal DPM-CS, the digital-potentiometer-control unit 90 turns on a predetermined switch 94 from among a plurality of switches 94 in the potentiometer as shown in FIG. 16. In FIG. 16, when a switch 94′ from among the plurality of switches 94 is turned on, for example, the resistance between VL and VW is set to (r1+r2+r3) and the voltages are divided.

Since a digital potentiometer which selects a predetermined resistance in accordance with a selection signal from the digital-potentiometer-control unit 90 is used, a gradation-reference voltage for each color of emission light can be set with ease and the size of the device can be reduced.

Since the gradation-reference-voltage-generation circuit is incorporated to the gradation-voltage-generation circuit 72, the reduction of the device size is enhanced. Note that a plurality of the gradation-reference-voltage-generation circuits 52 may also be used in the fourth embodiment.

### Fifth Embodiment

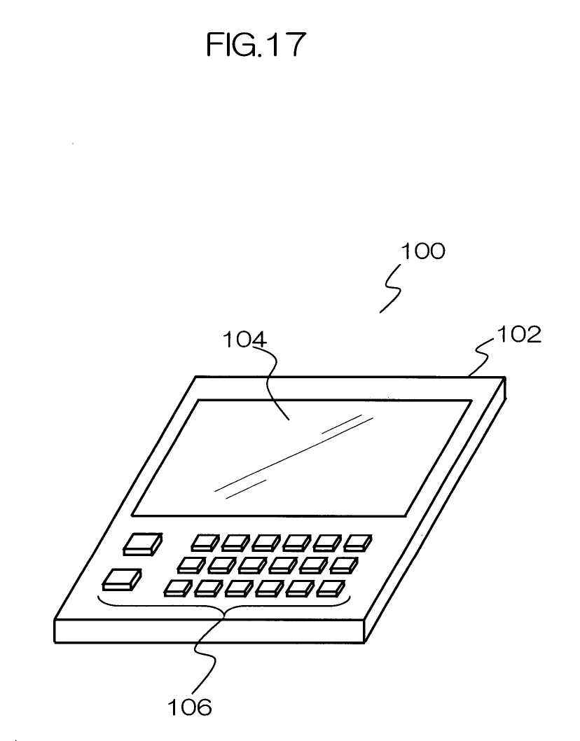

Referring to FIG. 17, a fifth embodiment in which a liquid crystal display device of the present invention is employed in a mobile terminal will be described. In FIG. 17, a mobile terminal 100 includes a liquid crystal display device 104 according to the present invention in a housing 102 made of a resin. The liquid crystal display device 104 has a plurality of keys 106 arranged on a lower side of the housing relative to the liquid crystal display device 104. The keys 106 are used for inputting desired characters and selecting icons displayed on the liquid crystal display device 104. In the liquid crystal display device 104 according to the present invention, a single pixel is used as a single display pixel and even when a display area is small, display with higher accuracy and color display of image data with higher quality can be achieved compared with known liquid crystal display devices.

In the foregoing first to fifth embodiments, a ferroelectric liquid crystal or an anti-ferroelectric liquid crystal is used as a liquid crystal material, and a time-division color method for switching colors of a backlight among RGB color components is used. However, the present invention is appropriately used in a color method for emitting white light from the rear side of liquid crystal elements toward color filters arranged on the front side of the liquid crystal elements.

According to the present invention, as described in detail above, a liquid crystal display device which can control a gradation-reference voltage generated in a gradation-reference-voltage-generation circuit for each display color, which can control a γ characteristic curve for the display color without γ correction of display data, and which has an excellent gradation display characteristic can be realized.

1. A liquid crystal display device having liquid crystal elements, comprising:
a plurality of gradation-reference-voltage circuits for generating gradation-reference voltages to be applied to the liquid crystal elements in accordance with a plurality of gradation levels of a color of light emitted from the liquid crystal elements.

2. The liquid crystal display device according to claim 1,
wherein the emitted light has a plurality of colors and the gradation-reference-voltage circuits generate gradation-reference voltages corresponding to the plurality of colors of the emitted light.

3. A liquid crystal display device having liquid crystal elements, comprising:
a source driver having a digital-to-analog conversion circuit for converting display data, which is digital data input to the liquid crystal display device, into analog voltages to be applied to the liquid crystal elements; and
a gradation-reference-voltage-generation unit for generating a plurality of groups of the analog voltages used for converting the display data into the corresponding analog voltages by means of the digital-to-analog conversion circuit,
wherein the source driver converts the digital data into analog voltages for display colors included in the display data in accordance with one of the plurality of groups of analog voltages.

4. A liquid crystal display device having liquid crystal elements, comprising:
a source driver having a digital-to-analog conversion circuit for converting display data, which is digital data input to the liquid crystal display device, into analog voltages to be applied to the liquid crystal elements;
a gradation-reference-voltage-generation unit for generating a plurality of groups of the analog voltages used for converting the display data into the corresponding analog voltages by means of the digital-to-analog conversion circuit; and
a g-correction circuit for correcting gradation of the display data,
wherein a group of the analog voltages based on gradation correction performed by means of the g-correction circuit and each of display colors is selected in synchronization with display of the display colors corresponding to the display data on the liquid crystal element for corresponding display color data in the display data, and the display data is displayed.

5. A liquid crystal display device having liquid crystal elements, comprising:
a source driver having a digital-to-analog conversion circuit for converting display data, which is digital data input to the liquid crystal display device, into analog voltages to be applied to the liquid crystal elements;
a gradation-reference-voltage-generation unit for generating a plurality of groups of the analog voltages used for converting the display data into corresponding analog voltages by means of the digital-to-analog conversion circuit;
a g-correction circuit for correcting gradation of the display data; and
a backlight capable of switching a color of emitted light among a plurality of colors of emitted light and disposed on a rear side of the liquid crystal elements,
wherein a group of the analog voltages for the corresponding display color is selected in accordance with display color data in the display data, and luminance of emitted light from the backlight is controlled.

6. The liquid crystal display device according to any one of claims 1 to 5, wherein each of the liquid crystal elements includes a liquid crystal material having spontaneous polarization.

7. The liquid crystal display device according to claim 6, wherein the liquid crystal material is a ferroelectric liquid crystal or an anti-ferroelectric liquid crystal.

8. A liquid crystal display device comprising:
a gradation-reference-voltage-generation circuit for generating reference voltages for gradation display required for digital-to-analog conversion of display data by an LCD-source-driver IC which is a source driver in the liquid crystal display device configured as an integrated circuit, wherein gradation-reference-voltage-generation circuit includes a gradation-reference- voltage-generation circuit which generates at least two types of group of gradation-reference voltages to be supplied to the LCD source driver IC and switches between the groups of the gradation-reference voltages for colors in synchronization with corresponding display colors.

9. A liquid crystal display device comprising:
a gradation-reference-voltage-generation circuit for generating reference voltages for gradation display required for digital-to-analog conversion of display data by an LCD-source-driver IC which is a source driver in the liquid crystal display device configured as an integrated circuit, wherein the gradation-reference-voltage-generation circuit includes a gradation-reference-voltage-generation circuit which generates at least two types of group of gradation-reference voltages to be supplied to the LCD source driver IC and switches between the groups of the gradation-reference voltages for colors in synchronization with corresponding display colors, and a g-correction circuit for correcting gradation of display data input to a display device, and wherein the gradation-reference-voltage-generation circuit and the g-correction circuit are used in cooperation with each other in synchronization with each of the display colors, and a group of the voltages output from the gradation-reference-voltage-generation circuit and a correction method used in the g-correction circuit are changed for each of the display colors.

10. A liquid crystal display device comprising:
a gradation-reference-voltage-generation circuit for generating reference voltages for gradation display required for digital-to-analog conversion of display data by an LCD-source-driver IC which is a source driver in the liquid crystal display device configured as an integrated circuit, wherein the gradation-reference-voltage-generation circuit includes a gradation-reference- voltage-generation circuit which generates at least two types of group of gradation-reference voltages to be supplied to the LCD source driver IC and switches between the groups of the gradation-reference voltages for colors in synchronization with corresponding display colors, a g-correction circuit for correcting gradation of display data input to a display device, and a backlight-control circuit for controlling, for each of the display colors, emission luminance from a backlight disposed on a rear side of the liquid crystal elements, and wherein the gradation-reference-voltage-generation circuit, the g-correction circuit, and the backlight-control circuit are used in cooperation with one another in synchronization with each of the display colors, and a group of the voltages output from the gradation-reference-voltage-generation circuit, a correction method used in the g-correction circuit, and luminance of emitted light from the backlight controlled by the backlight-control circuit are changed for each of the display colors.

11. A mobile terminal having the liquid crystal display device set forth in claims 1 to 5 and 8 to 10.
